(19) United States
(12) Patent Application Publication
(10) Pub. No.: US 2003/0163534 A1
(43) Pub. Date: Aug. 28, 2003

(54) Method of using internet to build a connection among transmitting devices

(76) Inventor: Chin-Hsien Huang, Taipei Hsien (TW)

Correspondence Address: BRUCE H. TROXELL, SUITE 1404, 5205 LEESBURG PIKE, FALLS CHURCH, VA, 22041, US

(21) Appl. No.: 10/173,640

(22) Filed: Jun. 19, 2002

(30) Foreign Application Priority Data
Feb. 27, 2002 (TW) 091103709

(51) Int. Cl. G06F 15/16

(52) U.S. Cl. 709/206

(57) ABSTRACT

A method of using Internet to build a connection among transmitting devices at least comprises the following steps:

(a) issuing an E-mail with message from computer A to request making a connection connected to computer B;

(b) by using a connecting module operated for connection to inspect whether an E-mail issued back from computer B is received; and

(c) if said E-mail already received, said connecting module operated for connection of computer A uses said IP address transmitted from computer B to build a connection connected between said transmitting device A and transmitting device B without through the other party's connection.

By repeatedly using the same method of this invention, computer A may simultaneously connect to another computer C also, so that the users of Internet may build a multi-lateral connection simultaneously connected among several different computers.

### BACKGROUND OF THE INVENTION

1. Field of the Invention

The present invention relates to a method of using Internet to build a connection capably connected among different computers, and more particularly to a method of using E-mail to transmit message for connection requested, transmit IP address of computers needed to be connected, and then capably transmit immediate digital information of video and audio.

2. Description of Related Art

It is very convenient to transmit video/audio information via Internet. Any immediate digital information of video/audio may be synchronously transmitted or received via Internet also. So far a designated Server of Internet Service provider is a passage for users to mutually transmit immediate digital information of video/audio via Internet. Both personal computers (PC) of user A and user B for mutually transmitting immediate digital information of video/audio via Internet must be connected with the designated Server of Internet Service provider simultaneously. Accordingly mentioned above, to be allowed mutual connection to proceed mutually transmitting immediate digital information of video/audio via Internet, both the user A and the user B must be registered, and even pay extra cost, as a member of a designated Internet Service provider. As far as users concerned, to mutually transmitting immediate digital information of video/audio via Internet is always not a convenient way to user; otherwise, it can not keep confidential matters of users in secret when those users are to transmit information via Internet. Nevertheless, for E-mail address, it is a very common way to recognize identity of person who is registered as a user of Internet, and it is also an absolutely effective way to look for certain relative person by registered E-mail address.

### SUMMARY OF THE INVENTION

The invention is invented to provide a method of using E-mail to look for certain relative person and build a connection in between their computers without passing through a specific designated Server of Internet Service provider, and to keep confidential matters of users in secret when users are to transmit immediate digital information of video and audio.

The primary objective of this invention is to provide a method to connect two computers by using Internet to immediately obtain the other party's IP address of computer.

Another objective of this invention is to provide a method of keeping one's secret to transmit immediate digital information of video and audio without through specific designated Server of Internet Service provider.

### BRIEF DESCRIPTION OF THE DRAWINGS

The invention is described in detail with reference to the following drawings, wherein like numerals represent like elements:

FIG. 1 is a functional block diagram of this invention to illustrate the computers connected via Internet.

FIG. 2 is a block diagram of this invention.

### DETAILED DESCRIPTION OF THE PREFERRED EMBODIMENT

This invention is to provide a method to immediately obtain the other party's IP address of transmitting device via Internet, without passing through a specific designated Server of Internet Service provider, capably to transmit immediate digital information of video and audio mutually. This invention makes use of E-mail address, which may be taken to recognize identity of a person who is registered as a user of Internet, to look for said person's IP address of transmitting device such as computer. For all users who does not know the other party's IP address of transmitting device and using floating IP address of transmitting device through telephone modem to be connected on Internet, such as those transmitting devices used for mobile business, transmit service by satellite, wireless internet transmit service (i.e. such as computer, personal notebook computer, mobile telephone capable connected on Internet and PDA etc.) and TV cable wideband Internet service, can make use of mutual E-mail address of users to look for the other party's IP address of transmitting device to build a connection in between mutual transmitting devices. By this way user can increase more parties connected to build a multi-lateral connections simultaneously and to transmit immediate digital information of video and audio mutually

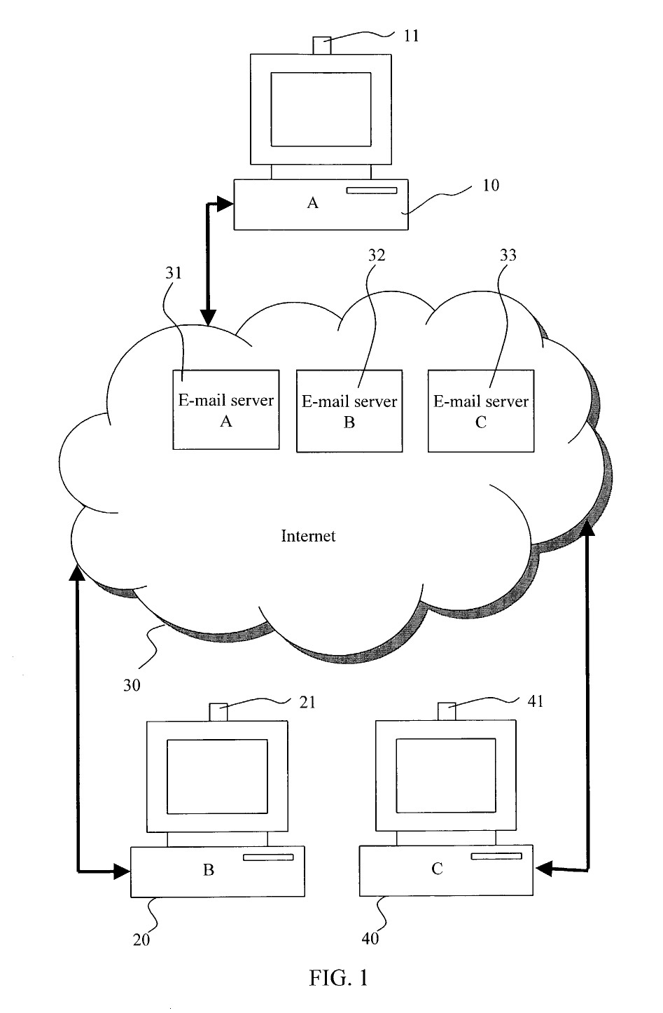

Referring to FIG. 1, the hardware of this invention reduced to practice at least comprises computer A 10, computer B 20, Internet 30, E-mail server A 31, and E-mail server B 32. Where said E-mail server A 31 and said E-mail server B 32 may be used the same E-mail server also. Each said computer A 10 and said computer B 20 are provided with a recording device respectively, each connected to an Video/Audio Capture device 11 and Video/Audio Capture device 21 respectively. User A uses computer A 10 through said E-mail server A 31 via Internet 30 to issue an E-mail message of requesting connection transmitted to said E-mail server B 32. User B uses computer B 20 through said E-mail server B 32 via Internet 30 to receive an E-mail message of requesting connection issued by computer A 10, and to issue back an E-mail message of accepting connection with its own on-line IP address transmitted to said computer A 10; after the message issued back by computer B is received to computer A, the connection applied connecting module operation in between computer A and computer B is built; so that said user A or said user B can use his/her own computer A 10 or computer B 20 via Internet respectively to transmit immediate digital information of video/audio captured by relative said capture device 11 or 21 and their relative recording devices. After said computer A 10 and said computer B 20 is mutually connected, this invention may further connect said computer A 10 and said computer B 20 with another computer C 30 respectively to build a connection simultaneously among said computer A 10, said computer B 20 and said computer C.

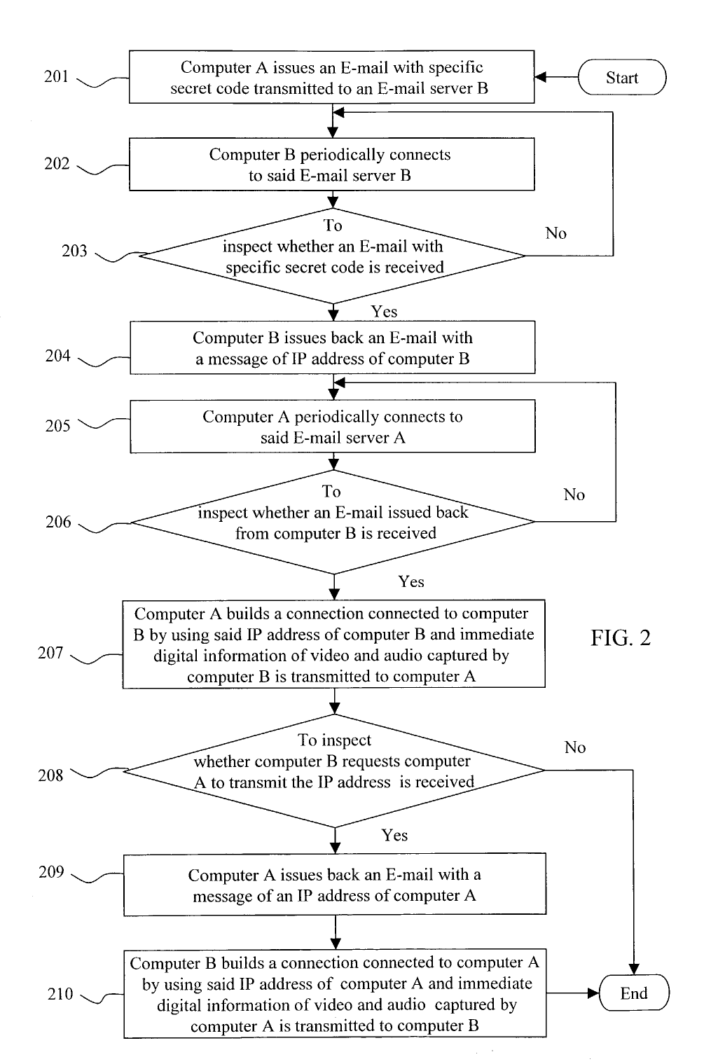

Referring to FIG. 2, the method of this invention reduced to practice comprises the following steps:

Step 201 computer A issues an E-mail with specific secret code transmitted to an E-mail server B via Internet;

Step 202 computer B periodically connects to said Email server B by using a connecting module operated for connection;

Step 203 to inspect whether an E-mail with specific secret code is received, and go to step 204 if said Email already received, otherwise, continually to proceed step 202 and step 203;

Step 204 computer B issues back an E-mail with a message of an IP address of computer to be connected and transmitted to computer A;

Step 205 computer A periodically connects to an E-mail server A by using a connecting module operated for connection;

Step 206 to inspect whether an E-mail issued back from computer B is received, and go to step 207 if said Email already received, otherwise, continually to proceed step 205 and step 206;

Step 207 said connecting module operated for connection of computer A uses said IP address transmitted from computer B to build a connection connected between said computer A and computer B; then immediate digital information of video and audio captured by computer B is capably transmitted to computer A;

Step 208 said computer A is to inspect whether said computer B requests said computer A to transmit the IP address of computer A needed to make a connection immediately; then go to step 209 if requested;

Step 209 computer A issues back an E-mail with a message of an IP address of computer A to be connected and transmitted to computer B;

Step 210 said computer B builds a connection connected to said computer A by using said IP address transmitted from computer A; then immediate digital information of video and audio captured by computer A is capably transmitted to computer B.

By the method mentioned above, two different users of Internet may build a connection connects his/her own computers in between, and, further to repeat said method more and more, the users of Internet may build a multi-lateral connection simultaneously connected among several different computers. Once a requested party is not received an E-mail issued back from the other party, it is meant said party requested for connection is not on Internet or unwilling to build a connection connected to said requested party, as nobody answers a telephone dialed it is probably meant nobody is in there or somebody is unwilling to answer a telephone resulted in the connection disconnected.

The IP address of computer called above is just the practical Internet Protocol Address used to build a connection on Internet, but said IP address of computer may also be floating IP address or virtual IP address. This invention is capably applied within an identical local area network (LAN) to build a connection among computers by using its virtual IP address to transmit immediate digital information of video and audio.

This invention uses an user's own E-mail address, unnecessarily making an extra registry or not connect to an Internet service provider provided with a service of transmitting immediate video and audio, and even without paying any extra cost, may via Internet build a connection through mutually respective IP address of computers to connect said user's computer to the other user's computer which said other user has an E-mail address too. Therefore, this invention disclosed may increase more parties connected to build a multi-lateral connections simultaneously and to transmit immediate digital information of video and audio mutually or read/write those file's information saved on the other party's computer. Accordingly, this invention has several advantages, namely, to transmit immediate digital information of video and audio via Internet more conveniently, more privately and more capably saving cost due to without paying extra transmitting cost, etc,.

The scope of this disclosed invention is not limited to the embodiment illustrated as above. Which scope explained and defined by claims may include all changeable equivalents more particularly only changed in easy amendment or variation.

What is claimed is:

1. A method of using Internet to build a connection among transmitting devices at least comprises the following steps:
(a) a transmitting device A issues an E-mail with message of connection requested transmitted to an Email server B;
(b) a transmitting device B periodically connects to said E-mail server B to inspect whether an E-mail issued from said transmitting device A; and if said Email received, then go to step (c);
(c) said transmitting device B issues back an E-mail with message of an IP address of transmitting device B to be connected and transmitted to transmitting device A;
(d) said transmitting device A periodically connects to an E-mail server A by using a connecting module operated for connection to inspect whether an E-mail issued back from transmitting device B is received; and if said E-mail already received, then go to step (e); and
(e) said connecting module operated for connection of transmitting device A uses said IP address transmitted from transmitting device B to build a connection connected between said transmitting device A and transmitting device B.

2. The method of using Internet to build a connection among transmitting devices as defined by claim 1, wherein said step (a) further comprising transmitting device A issues an E-mail with specific secret code transmitted to an E-mail server B; and said step (b) said transmitting device B periodically connects to said E-mail server B by using a connecting module operated for connection to inspect whether said E-mail with secret code issued from said transmitting device A is received.

3. The method of using Internet to build a connection among transmitting devices as defined by claim 2, wherein after step (e) more further comprising the following steps:
(f) said transmitting device A is to inspect whether said transmitting device B requests said transmitting device A to transmit the IP address; and if requested, then go to step (g);
(g) said transmitting device A issues back an E-mail with message of an IP address to be connected and transmitted to transmitting device B; and
(h) said connecting module operated for connection of transmitting device B uses said IP address transmitted from transmitting device A to build a connection connected between said transmitting device A and transmitting device B.

4. A method of using Internet to build a connection among transmitting devices at least comprises the following steps:
(a) a transmitting device A issues an E-mail with message of connection requested transmitted to an Email server B;
(b) said transmitting device A periodically connects to an E-mail server A by using a connecting module operated for connection to inspect whether an E-mail issued back from transmitting device B is received; and if said E-mail already received, then go to step (c); and
(c) said connecting module operated for connection of transmitting device A uses said IP address transmitted from transmitting device B to build a connection connected between said transmitting device A and transmitting device B.

5. The method of using Internet to build a connection among transmitting devices as defined by claim 4, wherein said step (a) further comprising transmitting device A issues an E-mail with specific secret code.

6. The method of using Internet to build a connection among transmitting devices as defined by claim 5, wherein after step (c) more further comprising the following steps:
(d) said transmitting device A is to inspect whether said transmitting device B requests said computer A to transmit the IP address; and if requested, transmitting device then go to step (e); and
(e) said transmitting device A issues back an E-mail with message of an IP address to be connected and transmitted to transmitting device B.

7. A method of using Internet to build a connection among transmitting devices as defined by claim 4, wherein after step (c) more further comprising the following steps:
(d) said transmitting device A issues an E-mail with message of connection requested transmitted to an Email sever C;
(e) said transmitting device A periodically connects to said E-mail server A by using a connecting module operated for connection to inspect whether an E-mail issued back from transmitting device C is received; and if said E-mail already received, then go to step (f); and
(f) said connecting module operated for connection of transmitting device A uses said IP address transmitted from transmitting device C to build a connection connected between said transmitting device A and transmitting device C.

8. The method of using Internet to build a connection among transmitting devices as defined by claim 7, wherein said step (a) and step (b) further comprising transmitting device A issues an E-mail with specific secret code.
